(19) United States
(12) Patent Application Publication
(10) Pub. No.: US 2026/0106670 A1
(43) Pub. Date: Apr. 16, 2026

(54) ORBITING OPTICAL ROUTER FOR INTERSATELLITE COMMUNICATIONS

(71) Applicant: SpaceRake, Inc., Cambridge, MA (US)

(72) Inventors: Jordan Wachs, Sudbury, MA (US); Kerri L. Cahoy, Concord, MA (US); Brian Mathason, Lexington, VA (US); Weston A. Marlow, Lanesborough, MA (US); Jeremy M. Wertheimer, Brookline, MA (US)

(73) Assignee: SpaceRake, Inc., Cambridge, MA (US)

(21) Appl. No.: 18/912,196

(22) Filed: Oct. 10, 2024

(51) Int. Cl. H04B 10/118; G02B 27/09; H04Q 11/00

(52) U.S. Cl. CPC H04B 10/118; G02B 27/0938; H04Q 11/0005; H04Q 2011/0037

(57) ABSTRACT

An optical router configured to facilitate communication between a satellite communication constellation and a plurality of satellite nodes is provided. The optical router comprises an upstream interface configured to facilitate communication over an upstream communication link to the satellite communication constellation, a downstream interface configured to simultaneously communicate via a single optical aperture with the satellite nodes over a plurality of downstream optical communication links in different directions, the plurality of optical communication links being established, and a controller to direct operation of the optical router.

### CROSS-REFERENCE TO RELATED APPLICATION

The present application claims priority pursuant to 35 U.S.C. § 119 of U.S. Provisional Patent Application Ser. No. 63/589,869, entitled “Methods and systems for intersatellite communication”, filed Oct. 12, 2023.

### FIELD

The presently disclosed subject matter relates to satellite communication systems, and in particular those which are configured to establish and maintain optical communication links.

### BACKGROUND

Satellites, for example in low Earth orbit, are deployed for a variety of purposes. In order to facilitate communication with them, networks of high-bandwidth optical communications satellites are established to provide global data transmission. According to some designs, the network includes a group, or “constellation”, of communication satellites, operating using free-space optical (FSO) communication (sometimes referred to as “lasercom”) links.

This solution may provide global availability of high-speed network access to satellites in low Earth orbit. However, it requires that satellites be able to maintain optical communication links with the constellation at distances often exceeding 5,000 km, which smaller satellites may not be equipped to achieve. It is therefore desirable to have apparatus and configurations which enable small satellites to establish and maintain reliable FSO communication links in orbital constellations. This goal is attained by embodiments of the present invention.

### SUMMARY

According to an aspect of the presently disclosed subject matter there is provided an orbiting optical router configured to facilitate communication between a satellite communication constellation and a plurality of satellite network nodes, the optical router including:
an upstream interface configured to facilitate communication over an upstream communication link, which may be, e.g., an optical or a radio-frequency communication link, to the satellite communication constellation; and
a downstream interface configured to simultaneously communicate with the satellite nodes over a plurality of downstream optical communication links in different directions, the plurality of optical communication links being established via a single optical aperture; and
a controller to direct operation of the optical router.

The optical router may be configured to define a hotspot within which the downstream optical communication links are established.

It may be further configured to define two or more zones within the hotspot, wherein the wavelength of each of the downstream optical communication links is unique within each of the zones, i.e., each of the downstream links within a zone has a different wavelength from all other links in that zone.

It may be further configured to define two or more zones within the hotspot, wherein the downstream optical communication links within each of the zones are time-division multiplexed.

Each of the downstream optical communication links may comprise a modulated beam, the downstream interface comprising a transmitting array comprising a plurality of transmission assemblies each configured to produce an outgoing one of the beams for transmission over its respective optical communication link, and an aperture assembly defining the optical aperture.

Each of the transmission assemblies may comprise a laser configured to produce one of the outgoing beams along an outgoing beam path, and a transmission lens assembly configured to adjust parameters of the outgoing beam.

The transmission lens assembly may comprise a focusing lens configured to adjust the spread of the outgoing beam and/or one or more positioning lenses each configured to adjust the direction of the outgoing beam.

The focusing lens and/or the positioning lenses may be liquid lenses, the controller being configured to apply an electrical signal to selectively change the shape of one or more of the lenses of the transmission lens assembly, thereby adjusting a respective parameter of the outgoing beam.

The focusing lens and/or the positioning lenses may be solid lenses, the controller being configured to operate an actuator to selectively adjust the position and/or orientation of one or more of the lenses of the transmission lens assembly, thereby adjusting a respective parameter of the outgoing beam.

The downstream interface may further comprise a transmitting steering arrangement configured to facilitate determination of positions of the outgoing beams, the controller being configured to operate one or more of the transmission assemblies to adjust the position of its respective outgoing beam based on information provided by the transmitting steering arrangement.

The transmitting steering arrangement may comprise a transmitting steering camera and an outgoing beam splitter, the outgoing beam splitter being configured to split each of the outgoing beams into a first portion emitted therefrom toward the transmitting steering camera, and a second portion emitted therefrom toward the optical aperture.

The outgoing beam splitter may be a non-symmetric beam splitter, wherein each of the second portions comprises more of the original outgoing beam than does its corresponding first portion.

The outgoing beam splitter may be further configured to emit one or more beams of light from the optical aperture in a direction away from the transmitting array and away from the transmitting steering camera.

The downstream interface may further comprise a receiving array comprising a plurality of receptor assemblies each configured to receive an incoming one of the beams, for receiving a transmission sent over its respective optical communication link.

Each of the receptor assemblies may comprise a receiver configured to receive one of the incoming beams along an incoming beam path, and a receptor lens assembly configured to adjust parameters of the incoming beam.

The receptor lens assembly may comprise a focusing lens configured to adjust the spread of the incoming beam and/or one or more positioning lenses each configured to adjust the direction of the incoming beam.

The focusing lens and/or the positioning lenses may be liquid lenses, the controller being configured to apply an electrical signal to selectively change the shape of one or more of the lenses of the receptor lens assembly, thereby adjusting a respective parameter of the incoming beam.

The focusing lens and/or the positioning lenses may be solid lenses, the controller being configured to operate an actuator to selectively adjust the position and/or orientation of one or more of the lenses of the receptor lens assembly, thereby adjusting a respective parameter of the incoming beam.

The downstream interface may further comprise a receiving steering arrangement configured to facilitate determination of positions of the incoming beams, the controller being configured to operate one or more of the receptor assemblies to adjust the position of its respective incoming beam based on information provided by the receiving steering arrangement.

The receiving steering arrangement may comprise a receiving steering camera and an incoming beam splitter, the incoming beam splitter being configured to split each of the incoming beams into a first portion emitted therefrom toward the receiving steering camera, and a second portion emitted therefrom toward a respective one of the receptor assemblies. The incoming beam splitter may be a non-symmetric beam splitter, wherein each of the second portions comprises more of the original outgoing beam than does its corresponding first portion.

The incoming beam splitter may be further configured to emit one or more beams of light from the optical aperture in a direction away from the receiving array and away from the receiving steering camera.

The receiving array may comprise a receiving guiding assembly configured to direct each of a plurality of the incoming beams received via the optical aperture from an incoming beam corridor toward a respective one of the receptor assemblies.

The transmitting array may comprise a transmitting guiding assembly configured to direct a plurality of the outgoing beams emitted from the transmission assemblies toward substantially parallel paths along an outgoing beam corridor of a lateral size no larger than that of the optical aperture.

The transmitting guiding assembly and/or the receiving guiding assembly may comprise a plurality of mirrors configured to facilitate directing the beams.

One or more of the mirrors may be dichroic. One or more of the mirrors may be semi-transparent.

The transmitting guiding assembly and/or the receiving guiding assembly may further comprise a relay lens disposed in the beam corridor.

Each of the downstream optical communication links may comprise a modulated beam, the downstream interface comprising:
a transmitting array comprising one or more transmission assemblies each configured to produce an outgoing one of the beams for transmission over its respective optical communication link;
an aperture assembly defining the optical aperture; and
a diffusive device comprising an incident surface and a transmission surface, the diffusive device being configured to transmit each of the outgoing beams from its transmission surface toward a predetermined location of the optical aperture, wherein the predetermined location is dependent on the location the outgoing beam impinges on the incident surface.

The transmitting array may comprise a plurality of transmission assemblies, each configured to produce a beam in a single direction.

The transmitting array may comprise a transmission assembly configured to selectively produce a plurality of outgoing beams, each in one of several directions.

Each of the transmission assemblies may comprise a light source configured to producing one of the outgoing beams, and a steering mechanism configured to direct the outgoing beam in a predetermined direction.

The light source may comprise a laser and/or an LED.

The steering mechanism may comprise a steering mirror, a mirror array, a micro-opto-electro-mechanical system assembly (e.g., a device, assembly, etc.), and/or a photonic steering arrangement.

The diffusive device may be configured to increase the diameter of the beam.

The diffusive device may be configured to transmit a beam toward the optical aperture having near-field characteristics which produce a predetermined far-field pattern.

The diffusive device may comprise an optical diffuser.

The diffusive device may comprise a holographic diffuser.

The diffusive device may comprise a metasurface and/or a microlens array.

The diffusive device may comprise ground glass.

The diffusive device may be planar and/or curved. The optical router may be configured to orbit the Earth and remain within a predefined maximum distance of each of the plurality of satellite nodes.

The upstream interface may be configured to communicate with a device configured to establish the upstream communication link.

According to another aspect of the presently disclosed subject matter, there is provided a system configured to facilitate communication between a satellite communication constellation and a plurality of satellite nodes, the system comprising:
an optical router as described above; and
a plurality of terminal modules configured to communicate with the optical router over an optical communication link, each of the terminal modules being configured to be attached to and to communicate with one of the satellite nodes.

According to another aspect of the presently disclosed subject matter, there is provided a method of communicating with a satellite node, the method comprising:
providing an optical router as described above;
establishing an upstream communication link between the optical router and a satellite communication constellation; and
establishing a downstream optical communication link between the satellite node and the optical router;

wherein the communication with the satellite node comprises transmitting information between the satellite node and the satellite communication constellation via the optical router.

According to another aspect of the presently disclosed subject matter, there is provided a free-space optical communication device configured to establish and simultaneously maintain a plurality of optical communication links with a plurality of nodes, each of the optical communication links comprising a modulated laser beam, the free-space optical communication device being configured to establish and maintain the plurality of optical communication links via a single optical aperture.

The free-space optical communication device may constitute a part of, or be configured to operate while being carried by, a vehicle. The vehicle may be an aerial vehicle.

The aerial vehicle may be one or more selected from the group including a rotary-wing aircraft, a fixed-wing aircraft, an aerostat, a satellite, and a spacecraft.

The free-space optical communication device may constitute a part of the optical router described above.

The free-space optical communication device may be a ground-based stationary device, for example orbited by one or more of the nodes.

At least one of the nodes may constitute a part of, or be configured to operate while being carried by, a vehicle. The vehicle may be an aerial vehicle.

The aerial vehicle may be one or more selected from the group including a rotary-wing aircraft, a fixed-wing aircraft, an aerostat, a satellite, and a spacecraft.

At least one of the nodes may constitute a part of the optical router described above.

At least one of the nodes may be a ground-based stationary device, for example orbited by one or more of the nodes and/or by the free-space orbital communication device.

At least one of the nodes may be a ground-based stationary device, for example orbited by one or more of the nodes and/or by the free-space orbital communication device, and one of the nodes may constitute a part of, or be configured to operate while being carried by, a vehicle. The vehicle may be an aerial vehicle.

Each of the communication links may carry a bitstream independent of those carried by the others of the communication links.

The free-space optical communication device may be further configured to facilitate communication between a communication network and the nodes.

The communication network may comprise at least one satellite, which may be part of a satellite communication constellation, in direct communication with the free-space optical communication device.

According to another aspect of the presently disclosed subject matter, there is provided an interface configured to simultaneously transmit a plurality of beams in different directions via a single optical aperture, the interface comprising
a transmitting array comprising one or more transmission assemblies each configured to produce an outgoing one ofthe beams for transmission in a predetermined; direction
an aperture assembly defining the optical aperture; and
a diffusive device comprising an incident surface and a transmission surface, the diffusive device being configured to transmit each of the outgoing beams from its transmission surface toward a predetermined location of the optical aperture, wherein the predetermined location is dependent on the location the outgoing beam impinges on the incident surface.
   The transmitting array may comprise a plurality of transmission assemblies, each configured to produce a beam in a single direction.

The transmitting array may comprise a transmission assembly configured to selectively produce a plurality of outgoing beams, each in one of several directions.

Each of the transmission assemblies may comprise a light source configured to producing one of the outgoing beams, and a steering mechanism configured to direct the outgoing beam in a predetermined direction.

The light source may comprise a laser and/or an LED.

The diffusive device may be configured to increase the diameter of the beam.

The diffusive device may be configured to transmit a beam toward the optical aperture having near-field characteristics which produce a predetermined far-field pattern.

The diffusive device may comprise an optical diffuser.

The diffusive device may comprise a holographic diffuser.

The diffusive device may comprise a metasurface and/or a microlens array.

The diffusive device may comprise ground glass.

The diffusive device may be planar and/or curved.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of a system for establishing intersatellite communication;

FIGS. 2A and 2B are side and front views, respectively, of a hotspot defined by an optical router of the system illustrated in FIG. 1;

FIG. 3 is a satellite node of the system illustrated in FIG. 1;

FIG. 4 is a schematic illustration of a downstream interface of an optical router of the system illustrated in FIG. 1; and

FIG. 5 is a schematic illustration of a modified downstream interface of an optical router of the system illustrated in FIG. 1.

### DETAILED DESCRIPTION

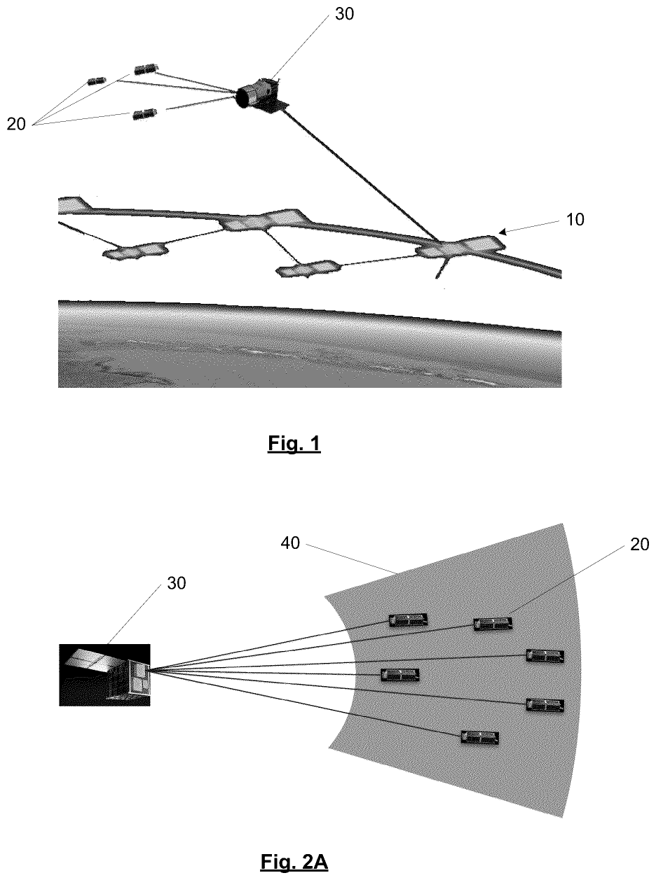

As illustrated in FIG. 1, there is provided a system configured to facilitate establishing a communication link between a satellite communication constellation, which is generally indicated at 10, and a plurality of satellite nodes 20 in orbit around the Earth. The system comprises an optical router 30, configured to forward network traffic, e.g., in the form of data packets, between one or more satellites of the satellite communication constellation 10 and a selected one of the satellite nodes 20, and vice versa.

Accordingly, the satellite nodes 20 can connect to a network established by the satellite communication constellation 10, without either having to establish and/or maintain a communication link with the other. The orbital router 30, on its downstream end, manages communication with the satellite nodes, and on its upstream end manages communication with the satellite communication constellation 10.

According to some examples, the optical router 30 is configured to facilitate communication over an upstream communication link, for example an optical communication link, with the satellite communication constellation 10, and a downstream optical communication link with each of the satellite nodes 20, thereby establishing a communication link between the satellite communication constellation and each of the satellite nodes, over which it forwards the network traffic.

According to some examples, the optical router 30 is configured to establish the upstream communication link.

According to other examples, optical router 30 is configured to communicate with a device which is configured to establish the upstream communication link. For example, the optical router 30 may constitute a secondary payload which is carried by a primary payload, wherein the primary payload is configured to establish the upstream communication link with the satellite communication constellation.

In order to establish and simultaneously maintain the plurality of downstream optical communication link with satellite nodes 20, the optical router 30 may be configured to produce a plurality of modulated optical communication beams to be steered in different directions simultaneously and independently, and to simultaneously receive a plurality of modulated optical communication beams from different directions.

According to some examples, the plurality of optical communication beams are produced and/or received via a single aperture of the optical router 30. According to other examples, the plurality of optical communication beams are produced and/or received via two or more apertures of the optical router 30.

According to some examples, the optical router 30 may produce/receive beams within a range of up to about 2π. steradians.

According to some examples, the optical router 30 may be configured to multiplex two or more of the downstream optical communication links, for example using space-division multiplexing, time-division multiplexing, and/or wavelength-division multiplexing.

As illustrated in FIG. 2A, the optical router 30 defines a hotspot 40 within which it establishes downstream optical communication links with satellite nodes 20. A satellite node 20 which is positioned and/or which positions itself within the hotspot 40 may establish a communication link with the satellite communication constellation via the optical router 30.

The range of the hotspot 40, i.e., the maximum distance from the optical router 30 that a satellite node 20 may be for a communication link to be established, may be any suitable distance, for example depending on operational parameters of the optical router and/or of the node. According to some examples, the optical router 30 may define different ranges within a single hotspot, each associated with different data transfer rates (e.g., a minimum and/or average data transfer rate), e.g., wherein typically larger distances from the optical router are associated with lower data transfer rates. According to some examples, the optical router 30 may define a hotspot 40 having a range of about 2000 km, 1500 km, 1000 km, or 500 km. According to some examples, the optical router 30 may establish downstream communication links with satellite nodes 20 within a first range at a data transfer rate of about 100 Mbps, and within a second range, larger than the first range, at a data transfer rate of about 50 Mbps.

According to some examples, the range may include a minimum distance that a satellite node 20 may be from the optical router 30.

When viewed from the optical router 30, the hotspot 40 is defined by a predefined subtended angle from the optical router, e.g., a field of view within which downstream communication links may be established with satellite nodes 20. As seen in FIG. 2B, two or more zones* 42 may be defined within a single hotspot. Each zone 42 may overlap one or more of the other zones. According to some examples, all of the downstream communication links established within a given zone 42 are of different wavelengths, enabling a single orbital router 30 to increase the number of downstream communication links it may establish within the hotspot 40 and avoid co-channel interference, while complying, e.g., with standards established by the International Telecommunications Union, IEEE, etc., governing the number of possible channels.

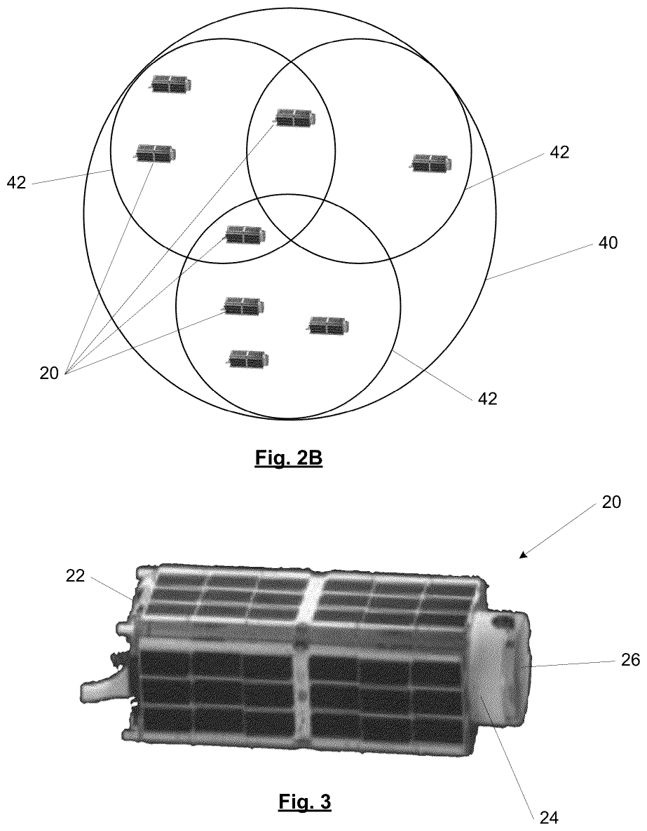

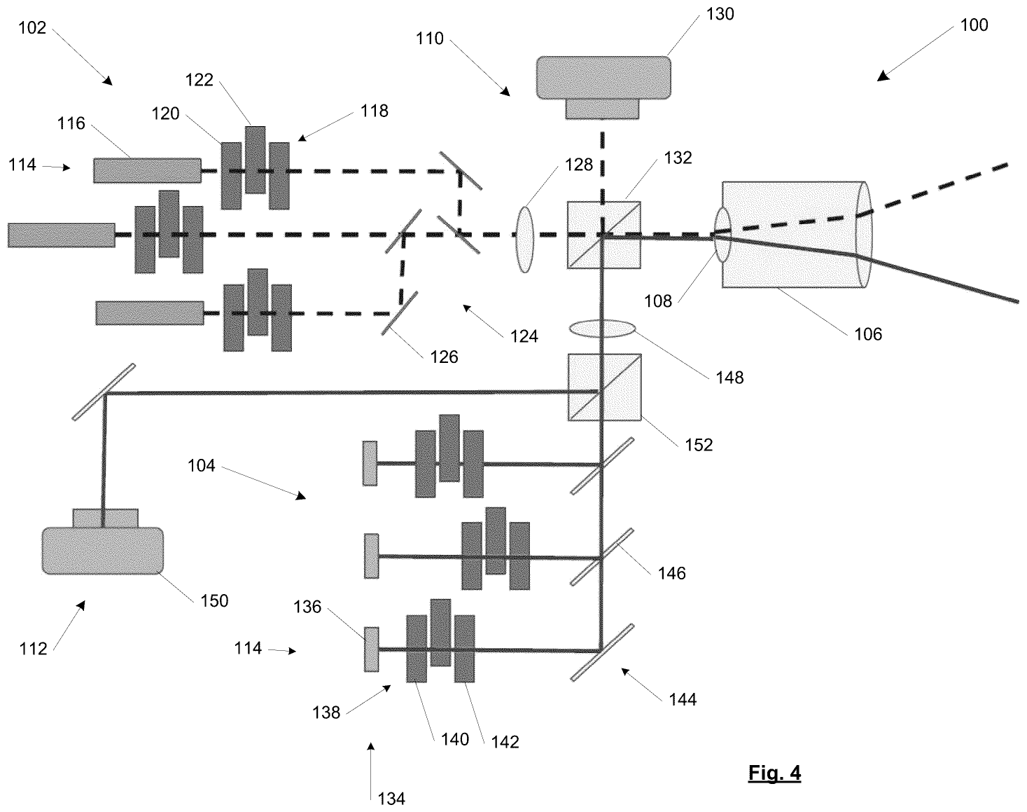

As illustrated in FIG. 3, each of the satellite nodes 20 comprises a satellite 22, and a communication terminal 24 mounted thereto and configured to facilitate establishing an upstream optical communication link with the optical router 30. The satellite may be any conventional satellite, for example a miniaturized satellite such as a microsatellite or a nanosatellite.

The communication terminal 24 may comprise an optical communication interface 26 configured to receive and produce optical communication beams, and is configured to communicate with the satellite 22, thereby fully establishing the upstream optical communication link.

According to some examples, the communication terminal 24 is further configured to direct operation of the satellite 22, for example to ensure that the satellite's position and/or orientation are suitable for maintaining the upstream optical communication link with the optical router 30. Accordingly, it may comprise an attitude determination and control system (ACDS), for example as is known in the art.

According to some examples, one or more of the satellite nodes 20 may comprise a satellite 22 as described above, and which is configured to carry out the functions, in whole or in part, of the communication terminal as described above. According to such examples, a separate communication terminal may not be provided.

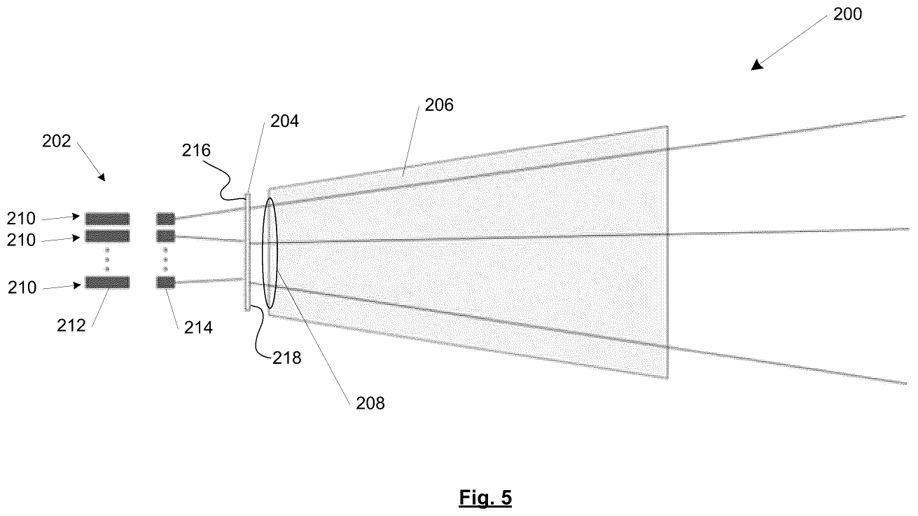

As illustrated in FIG. 4, the orbital router 30 comprises a downstream interface, which is generally indicated at 100, configured to facilitate simultaneously communicating with the satellite nodes 20 in a plurality of different direction, for example as described above. According to some examples, the downstream interface 100 is configured to establish the plurality of downstream optical communication links via a single aperture.

The orbital router 30 may further comprise a controller (not illustrated), configured to direct its operation including, inter alia, operation of the downstream interface 100. It will be appreciated that while herein the specification and claims, the term “controller” is used with reference to a single element, the controller may, in practice, comprise a combination of elements, including, but not limited to a plurality of controllers, which may or may not be in physical proximity to one another, without departing from the scope of the presently disclosed subject matter, mutatis mutandis. In addition, disclosure herein, including recitation in the appended claims, of a controller carrying out, being configured to carry out, or other similar language, implicitly includes other elements of the orbital router carrying out, being configured to carry out, etc., those functions, without departing from the scope of the presently disclosed subject matter, mutatis mutandis.

The downstream interface 100 comprises a transmitting array 102 configured to produce a plurality of outgoing beams, each being modulated to carry information to a satellite node 20 over a respective optical communication link, a receiving array 104 configured to receive individual incoming beams, for example having been modulated by one of the satellite nodes to carry information over a respective optical communication link, and an aperture assembly 106 defining the optical aperture 108. The downstream interface may further comprise a transmitting steering arrangement 110 and/or a receiving steering arrangement 112, configured to facilitate determining the positions of the outgoing and incoming beams, respectively.

The transmitting array 102 comprises one or more transmission assemblies 114, each comprising a laser 116 configured to produce one of the outgoing beams, and a transmission lens assembly 118 configured to adjust parameters of the outgoing beam, e.g., to facilitate steering and/or focusing of the outgoing beam. Accordingly, the transmission lens assembly 118 may comprise one or more adjustable lenses.

According to some examples, at least some of the adjustable lenses of the transmission lens assembly 118 are liquid lenses, wherein the controller is configured to selectively change the shapes of the liquid lenses to suitably adjust one or more beam parameters. According to some examples, at least some of the adjustable lenses of the transmission lens assembly 118 are solid lenses, wherein the controller is configured to selectively change the position and/or orientation of the solid lenses to suitably adjust one or more beam parameters.

According to some examples, the transmission lens assembly 118 comprises one or more focusing lenses 120 configured to adjust the spread of the outgoing beam. According to some examples, the transmission lens assembly 118 comprises one or more positioning lenses 122 configured to adjust the direction of the outgoing beam.

The transmitting array 102 may further comprise a transmitting guiding assembly 124 configured to collect the outgoing beams, i.e., to direct them, once emitted from the transmission assemblies 110, toward substantially parallel paths which lie in a relatively narrow outgoing beam corridor. The beam corridor is no larger than that of the optical aperture 108, i.e., a circle the size of the optical aperture would completely circumscribe its lateral cross-section, and contain all of the collected outgoing beams.

The transmitting guiding assembly 124 may comprise a plurality of mirrors 126 configured to facilitate directing the outgoing beams, ultimately toward the outgoing beam corridor. The transmitting guiding assembly 124 may further comprise a relay lens 128 disposed in the beam corridor.

According to some examples, some or all of the mirrors are dichroic. According to some examples, some or all of the mirrors are semi-transparent.

According to some examples, some or all of the mirrors comprise a segmented deformable mirror, for example “Hex Tip-Tilt-Piston” segmented deformable mirrors sold by Boston Micromachines Corporation of Cambridge, MA. Such deformable mirrors may be used to provide fine steering of the direction of an outgoing beam, for example within a tolerance of +/−0.5 deg.

As mentioned above, the transmitting steering arrangement 110 is configured to facilitate determining the positions of the outgoing beams. Accordingly, it is in communication with the controller, which is configured, based on input received from the transmitting steering arrangement 110 regarding the positions of the outgoing beams, to direct operation of, e.g., elements one or more of the transmission assemblies 114 to adjust the position of the outgoing beam.

According to some examples, the transmitting steering arrangement 110 diverts a portion of the outgoing beams from the outgoing beam corridor, and detects the positions of each of the constituent outgoing beams. The controller may interpret the positional data detected by the transmitting steering arrangement 110. Thus, the transmitting steering arrangement 110 constitutes part of a feedback mechanism to monitor and adjust the positions of the beams.

Accordingly, the transmitting steering arrangement 110 may comprise a transmitting steering camera 130 configured to detect the diverted portions of the outgoing beams, and an outgoing beam splitter 132 configured to split each of the outgoing beams into a first portion diverted toward the transmitting steering camera 130, and a second portion which is emitted toward the optical aperture 108.

According to some examples, the outgoing beam splitter 132 is a non-symmetric beam splitter, i.e., one which splits the outgoing beam unevenly. In particular, it may be configured such that second portions each comprise more of the original outgoing beam than do their corresponding first portions.

The receiving array 104 comprises one or more receptor assemblies 134, each comprising a receiver 136 configured to receive one of the incoming beams, and a receptor lens assembly 138 configured to adjust parameters of the incoming beam, e.g., to facilitate steering and/or focusing of the incoming beam toward a respective one of the receivers. Accordingly, the receptor lens assembly 138 may comprise one or more adjustable lenses.

According to some examples, at least some of the adjustable lenses of the receptor lens assembly 138 are liquid lenses, wherein the controller is configured to selectively change the shapes of the liquid lenses to suitably adjust one or more beam parameters. According to some examples, at least some of the adjustable lenses of the receptor lens assembly 138 are solid lenses, wherein the controller is configured to selectively change the position and/or orientation of the solid lenses to suitably adjust one or more beam parameters.

According to some examples, the receptor lens assembly 138 comprises one or more focusing lenses 140 configured to adjust the spread of the incoming beam toward the receiver 136. According to some examples, the receptor lens assembly 138 comprises one or more positioning lenses 142 configured to adjust the direction of the incoming beam toward the receiver 136.

The receiving array 104 may further comprise a receiving guiding assembly 144 configured to direct each of the incoming beams received via the optical aperture 108, from an incoming beam corridor toward a respective one of the receptor assemblies 134, i.e., to direct them from an incoming beam corridor defined by the optical aperture toward respective receptor assemblies.

The receiving guiding assembly 144 may comprise a plurality of mirrors 146 configured to facilitate directing the incoming beams from the incoming beam corridor, ultimately toward the receivers 136. The receiving guiding assembly 144 may further comprise a relay lens 148 disposed in the beam corridor.

According to some examples, some or all of the mirrors are dichroic. According to some examples, some or all of the mirrors are semi-transparent.

As mentioned above, the receiving steering arrangement 112 is configured to facilitate determining the positions of the incoming beams. Accordingly, it is in communication with the controller, which is configured, based on input received from the receiving steering arrangement 112 regarding the positions of the incoming beams, to direct operation of, e.g., elements one or more of the receptor assemblies 134 to adjust the paths of the incoming beams, so that they are received by the receivers 136.

According to some examples, the receiving steering arrangement 112 diverts a portion of the incoming beams from the incoming beam corridor, and detects the positions of each of the constituent incoming beams. The controller may interpret the positional data detected by the receiving steering arrangement 112. Thus, the receiving steering arrangement 112 constitutes part of a feedback mechanism to monitor and adjust the positions of the incoming beams.

Accordingly, the receiving steering arrangement 112 may comprise a receiving steering camera 150 configured to detect the diverted portions of the incoming beams, and an incoming beam splitter 152 configured to split each of the incoming beams into a first portion diverted toward the receiving steering camera, and a second portion which is emitted toward a respective one of the receptor assemblies 134.

According to some examples, the incoming beam splitter 152 is a non-symmetric beam splitter, i.e., one which splits the incoming beam unevenly. In particular, it may be configured such that second portions each comprise more of the original incoming beam than do their corresponding first portions.

According to some examples, the outgoing beam splitter 132 further functions as a mirror which directs the incoming beams. Accordingly, it may be configured to fully reflect light from the direction of the optical aperture 108 in a direction away from the transmitting array 102 and away from the transmitting steering camera 130, while at the same time, as described above, diverting a portion of light coming from the transmitting array toward the transmitting steering camera 130, and emitting a portion thereof toward the optical aperture.

According to some examples, such as is illustrated in FIG. 5, the orbital router may comprise a modified downstream interface, which is generally indicated at 200. It will be appreciated that while FIG. 5 does not illustrate a receiving array, for example as described above with reference to and as illustrated in FIG. 4, the downstream interface described herein with reference to and as illustrated in FIG. 5 may include a suitable receiving array. The receiving array may be provided according to any suitable design, including, but not limited to, as described above with reference to and as illustrated in FIG. 4, mutatis mutandis.

The downstream interface 200 comprises transmitting array 202 configured to produce a plurality of outgoing beams each oriented in a predetermined direction, a diffusive device 204 configured, inter alia, to transmit a beam corresponding to a beam incident thereon, and an aperture assembly 206 defining an optical aperture 208. Each of the outgoing beams may be modulated to carry information to a satellite node 20 over a respective optical communication link.

The transmitting array 202 comprises one or more transmission assemblies 210. Each of the transmission assemblies 210 may comprise a light source 212 for producing a beam, and a steering mechanism 214 configured to direct the beam produced by the light source in a predetermined direction, e.g., toward a predetermined location on the diffusive device 204. The beam may be directed to form a point on the diffusive device 204, or to impinge on an area thereof.

The light source 212 may comprise a laser, an LED, and/or any other suitable device for producing a beam. The steering mechanism 214 may comprise a steering mirror or mirror array, a micro-opto-electro-mechanical systems (MOEMS) device or assembly, a photonic steering arrangement, and/or any other suitable device for steering a beam produced by the light source.

Transmission assemblies 210 may include further supplementary optics configured to facilitate forming, focusing, dispersing, steering, filtering, etc., their respective beams. Accordingly, the transmission assemblies 210 may each comprise, e.g., separate from the light source 212 and/or steering mechanism 214, one or more fixed mirrors, steering mirrors, lenses, dichroic filters, prisms, diffraction gratings, etc.

The transmitting array 202 may comprise a plurality of transmission assemblies 210, for example wherein each is configured to produce an outgoing beam in a predetermined direction. According to some examples, the transmitting array 202 may comprise a single transmission assembly 210, configured to selectively produce a plurality of outgoing beams, each in one of several directions, for example alternating production of beams along different directions. According to some examples, the transmitting array comprises one or more transmission assemblies 210, each configured to produce a single outgoing beam, and one or more transmission assemblies 210, each configured to produce a plurality of outgoing beams selectively in several directions as described above.

It will be appreciated that while the transmission assemblies 210 are described herein as each comprising a discrete light source 212 and steering mechanism 214, this is for disclosure of a non-limiting example. In practice, each of the transmission assemblies 210 may be provided as a single element which produces a beam in a predetermined direction, without departing from the scope of the presently disclosed subject matter, mutatis mutandis. Moreover, the steering mechanism 214 may be configured to adjust the position of the light source 212 itself in order to direct the beam in a predetermined direction, without directly interacting with the beam, mutatis mutandis.

As mentioned above, the diffusive device 204 is configured, inter alia, to transmit a beam corresponding to a beam incident thereon. Accordingly, it comprises an incident surface 216 to be impinged upon by outgoing beams produced by the transmitting array 202, and a transmission surface 218 via which a beam is transmitted therefrom.

The diffusive device 204 may be configured to increase the diameter of the beam, i.e., a beam transmitted from its transmission surface 218 will have a larger diameter than the corresponding incident beam. Moreover, the diffusive device may be configured such that the beam is transmitted from the transmission surface 218 at a predetermined angle which is not dependent (within a relatively broad range) to the angle of incidence of the incident beam on the incident surface 216. Accordingly, a beam may be transmitted by the diffusive device 204 in a predetermined direction, e.g., toward a predetermined location of the optical aperture 208, substantially based only on the location it impinges on the incident surface 216. Thus, the incident beam may be transmitted from a relatively large area, i.e., the transmission assemblies 210 may be located in any suitable locations, without being restricted by the angle at which their respective beams impinge on the diffusive device 204.

Multiple beams may thus be transmitted from the diffusive device 204 toward respective locations on the optical aperture 208 without requiring that they be co-aligned, e.g., being transmitted in parallel, etc. In addition, the production of each beam may be controlled independently, provided the production of the other beams does not affect the location on which it impinges the incident surface 216 of the diffusive device 204. Accordingly, the design of the transmitting array 202 may be simplified, as beams produced thereby are not restricted to following a particular optical path prior to impinging on the diffusive device 204.

The diffusive device 204 may be further configured to transmit the beam toward the optical aperture 208 such that the phase and amplitude in the near-field produce a desired pattern of the beam in the far-field, thereby facilitating communication over a large distance.

The diffusive device 204 may be made of any suitable material and be of any suitable design. According to some examples, it comprises an optical diffuser, a metasurface, a microlens array, and/or any other suitable arrangement. According to some examples, the diffusive device comprises a holographic diffuser. According to other examples, it comprises ground glass or a similar substrate. The diffusive device may have any suitable shape, for example being planar, curved, or of any other suitable shape to facilitate the necessary optical properties, for example as described above.

The aperture assembly 206 may comprise a telescope, for example configured to facilitate transmission of beams transmitted by the diffusive device 204 to a remote satellite node 20, for example as described above.

It will be appreciated that while the downstream interfaces 100, 200 have been described herein with reference to their use in satellite communication systems for transmitting beams over long distances, this is by way of example only. One having skill in the art will recognize that the downstream interfaces 100, 200 and portions thereof (e.g., the transmitting array 102 and/or receiving array 104 of the downstream interface 100 described above with reference to and as illustrated in FIG. 4, and/or the transmitting array 202 described above with reference to and as illustrated in FIG. 5) may be provided for use in any suitable application, mutatis mutandis. Such applications may include, but are not limited to, microscopy and/or targeting utilizing multipoint illumination, light detection and ranging (LiDAR) systems, and/or any other application necessitating simultaneously controlling multiple beams.

It will be recognized that examples, embodiments, modifications, options, etc., described herein are to be construed as inclusive and non-limiting, i.e., two or more examples described separately herein are not to be construed as being mutually exclusive of one another or in any other way limiting, unless such is explicitly stated and/or is otherwise clear. Those skilled in the art to which this invention pertains will readily appreciate that numerous changes, variations, and modifications can be made without departing from the scope of the presently disclosed subject matter, mutatis mutandis.

1. An orbiting optical router for intersatellite communication between a satellite constellation and a plurality of satellite nodes, the optical router comprising:
an upstream interface configured to communicate over an upstream communication link from the satellite nodes to the satellite communication constellation;
a downstream interface configured to simultaneously communicate over a plurality of downstream optical communication links from the satellite communication constellation to the satellite nodes,
a transmitting array including one or more transmission assemblies each configured to produce an outgoing beam for transmission over a respective optical communication link;
wherein the optical router is further configured to comprise multiplexing of two or more of the plurality of_downstream optical communication links by space-division multiplexing;
a controller to direct operation of the optical router;
wherein the downstream optical communication links are in different directions, and
wherein the plurality of downstream optical communication links are established via a single optical aperture defined by an aperture assembly.

2. The optical router according to claim 1, wherein
a downstream optical communication link of the plurality of downstream optical communication links, includes a modulated beam, and
the downstream interface which includes the transmitting array.

3. The optical router according to claim 1, wherein each of the transmission assemblies includes:
a laser configured to produce an outgoing beam along an outgoing beam path, and
a transmission lens assembly configured to adjust parameters of the outgoing beam.

4. The optical router according to claim 3, wherein the transmission lens assembly includes:
at least one focusing lens configured to adjust a spread of the outgoing beam;
at least one positioning lens configured to adjust a direction of the outgoing beam; and
a diffusive device having an incident surface and a transmission surface, wherein the diffusive device is configured to transmit an outgoing beams from the transmission surface toward a predetermined location of the optical aperture.

5. The optical router according to claim 4, wherein the at least one of the focusing lens and the positioning lens is a liquid lens, and wherein the controller is configured to apply an electrical signal to selectively change the shape of a lens of the transmission lens assembly to adjust a parameter of the outgoing beam.

6. The optical router according to claim 5, wherein the at least one of the focusing lens and the positioning lens is a solid lens, the controller is configured to operate an actuator to selectively adjust at least one of the position and orientation of a lens of the transmission lens assembly to selectively adjust a parameter of the outgoing beam.

7. The optical router according to claim 2, wherein the downstream interface further comprises a transmitting steering arrangement configured to determine a position of an outgoing beam, and wherein the controller is configured to operate at least one transmission assembly to adjust a position of its respective outgoing beam, based on information provided by the transmitting steering arrangement.

8. The optical router according to claim 7, wherein the transmitting steering arrangement includes a transmitting steering camera and an outgoing beam splitter, wherein the outgoing beam splitter is configured to split an outgoing beam into a first portion emitted therefrom toward the transmitting steering camera, and a second portion emitted therefrom toward the optical aperture.

9. The optical router according to claim 8, the outgoing beam splitter being a non-symmetric beam splitter, wherein each of the second portions comprises more of the original outgoing beam than does its corresponding first portion.

10. The optical router according to claims 7, wherein the steering arrangement includes a steering mirror, a mirror array, and a micro-opto-electro-mechanical system assembly.

11. The optical router according to claim 8, the outgoing beam splitter being further configured to emit at least one beam of light from the optical aperture in a direction away from the transmitting array and away from the transmitting steering camera.

12. The optical router according to claim 1, wherein each of the transmission assemblies includes a light source configured to produce one of the outgoing beams, and a steering mechanism configured to direct the outgoing beam in a predetermined direction.

13. The optical router according to claim 3, the downstream interface further comprising a receiving array including a plurality of receptor assemblies each configured to receive an incoming beam, for receiving a transmission sent over an optical communication link.

14. The optical router according to claim 13, wherein each of the receptor assemblies includes a receiver configured to receive an incoming beam along an incoming beam path, and a receptor lens assembly configured to adjust a parameter of the incoming beam.

15. The optical router according to claim 14, wherein the receptor lens assembly includes a focusing lens configured to adjust the spread of the incoming beam and at least one positioning lens each configured to adjust the direction of the incoming beam.

16. The optical router according to claim 15, further comprising an incoming beam splitter.

17. The optical router according to claim 16, wherein the incoming beam splitter is a non-symmetric beam splitter, such that each of the second portions comprises more of the original incoming beam than the corresponding first portion.

18. The optical router according to claim 17, wherein the incoming beam splitter is further configured to emit at least one beam of light from the optical aperture in a direction away from the receiving array and away from the receiving steering camera.

19. The optical router according to claim 13, wherein the receiving array includes a receiving guiding assembly configured to direct an incoming beam received via the optical aperture from an incoming beam corridor toward a receptor assembly.

20. The optical router according claim 19, wherein the transmitting array includes a transmitting guiding assembly configured to direct at least two outgoing beams emitted from the transmission assemblies on substantially parallel paths along an outgoing beam corridor having a lateral size no larger than that of the optical aperture.
